(19) United States
(12) Patent Application Publication
(10) Pub. No.: US 2017/0353220 A1
(43) Pub. Date: Dec. 7, 2017

(54) DISTRIBUTED ANTENNA SYSTEMS WITH CONSTRAINTS ON THE AVERAGE NUMBER OF ACTIVE BACKHAUL LINKS

(71) Applicant: KABUSHIKI KAISHA TOSHIBA, Tokyo (JP)

(72) Inventor: Mohammud Zubeir BOCUS, Bristol (GB)

(73) Assignee: KABUSHIKI KAISHA TOSHIBA, Tokyo (JP)

(21) Appl. No.: 15/504,186

(22) PCT Filed: Feb. 26, 2015
(86) PCT No.: PCT/GB2015/050555

§ 371 Date: Feb. 15, 2017

(51) Int. Cl. H04B 7/06; H04B 7/024

(52) U.S. Cl. CPC H04B 7/0608; H04B 7/024

(57) ABSTRACT

In an embodiment, a remote radio head unit for a distributed antenna system is disclosed. The remote radio head unit comprises: an antenna configured to receive a radiofrequency signal; a storage module for storing a signal strength threshold; a comparison module configured to compare a signal strength of the radiofrequency signal with the signal strength threshold; and a backhaul communication module configured to send a signal derived from the received signal to a central unit of the distributed antenna system if the signal strength of the radiofrequency signal is greater than the signal strength threshold.

### FIELD

Embodiments described herein relate to distributed antenna systems and the distributed selection of remote radio heads for uplink in distributed antenna systems.

### BACKGROUND

Cooperation in wireless communication systems as a method to improve spectral and energy efficiency and performance have been extensively studied in the literature. Techniques include coordinated multipoint (CoMP) communication, also referred to as network multiple-input and multiple-output (MIMO), and Distributed Input Distributed Output (DIDO), among other terminologies, wherein different base stations cooperate to improve the overall network performance. Signal processing operations such as information decoding and pre-coding can either be performed in a distributed manner at the individual antenna locations or all the processing can be performed by a central unit to which all antennas/base stations are connected.

Massive MIMO, on the other hand, is another communication strategy that provides for an excess of antennas at one or both ends of a communication system. The motivation behind this scheme is to reduce effects such as noise, small-scale fading and improve the energy and spectrum efficiency of the network. Furthermore, as the size of the channel matrix in the system increases, it can be shown theoretically that the performance of a simple matched receiver approaches that of the more computationally intensive (Minimum Mean-Square Error) MMSE or Zero Forcing (ZF) receivers. However, these benefits rely on the channel between different antennas being uncorrelated. Due to the co-location of the large antenna arrays, the benefits of massive MIMO may be restricted in practice.

Large scale distributed antenna systems (L-DAS) provide a framework to exploit the advantages of large antenna arrays without the limitations due to co-location. In this setting, a large number of antennas, or remote radio heads (RRHs) are distributed within the environment and coordinate their transmission/reception strategies to enhance the overall network performance.

### BRIEF DESCRIPTION OF THE DRAWINGS

In the following, embodiments will be described with reference to the accompanying drawings in which:

FIG. 1 shows a distributed antenna system (DAS) according to an embodiment;

FIG. 2 shows a bit error rate (BER) comparison of an uplink DAS system with different numbers of remote radio heads (RRHs);

FIG. 3 shows a remote radio head (RRH) unit according to an embodiment;

FIG. 4 shows a method of forwarding a received signal from a RRH to a central unit (CU) according to an embodiment;

FIG. 5 shows a CU of a DAS according to an embodiment;

FIG. 6 shows a method in a DAS according to an embodiment;

FIG. 7 shows a method in a DAS according to an embodiment;

FIG. 8 shows an example of RRH selection in an embodiment; and

FIG. 9 shows bit error rate (BER) against signal to noise ratio (SNR) for an embodiments.

### DETAILED DESCRIPTION

In an embodiment, a remote radio head unit for a distributed antenna system is disclosed. The remote radio head unit comprises: an antenna configured to receive a radiofrequency signal; a storage module for storing a signal strength threshold; a comparison module configured to compare a signal strength of the radiofrequency signal with the signal strength threshold; and a backhaul communication module configured to send a signal derived from the received signal to a central unit of the distributed antenna system if the signal strength of the radiofrequency signal is greater than the signal strength threshold.

In an embodiment, the remote radio head unit further comprises a threshold calculation module configured to calculate the signal strength threshold from control information received from the central unit of the distributed antenna system.

In an embodiment, the control information received from the central unit of the distributed antenna system indicates a probability that the remote radio head unit will forward a signal to the central unit of the distributed antenna system.

In an embodiment, the backhaul communication module is further configured to receive an indication of the signal strength threshold from the central unit of the distributed antenna system.

In an embodiment, the remote radio head unit further comprises a radiofrequency module configured to generate a baseband signal from the radiofrequency signal, wherein the signal derived from the radiofrequency signal is the baseband signal.

In an embodiment, a signal processing method in a remote radio head unit of a distributed antenna system is disclosed. The method comprises: receiving a radiofrequency signal from a transmitter; comparing a signal strength of the radiofrequency signal with the signal strength threshold; sending a signal derived from the radiofrequency signal to a central unit of the distributed antenna system if the signal strength of the radiofrequency signal is greater than the signal strength threshold.

In an embodiment, the signal processing further comprises receiving control information from the central unit; and calculating the signal strength threshold from the control information.

In an embodiment, the signal processing further comprises receiving an indication of the threshold from the central unit.

In an embodiment, the signal processing further comprises determining a baseband signal from the radiofrequency signal and determining the signal strength of the radiofrequency signal from the baseband signal.

In an embodiment, the signal derived from the radiofrequency signal is the baseband signal.

In an embodiment, a central unit for a distributed antenna system is disclosed. The distributed antenna system comprises a plurality of remote radio head units. The central unit comprises a control information generation module configured to generate control information for use by the remote radio head units to determine whether to transmit a signal derived from a received signal to the central unit; and a communication module to send the control information to the remote radio head units.

In an embodiment, the control information comprises a probability that a remote radio head will transmit a signal derived from a received signal to the control unit.

In an embodiment, the control information comprises a received signal strength threshold.

In an embodiment, a method in a central unit of a distributed antenna system is disclosed. The distributed antenna system comprises a plurality of remote radio head units. The method comprises: generating control information for use by the remote radio head units to determine whether to transmit a signal derived from a received signal to the central unit; and sending the control information to the remote radio head units.

In an embodiment, the control information comprises a probability that a remote radio head will transmit a signal derived from a received signal to the control unit.

In an embodiment, the control information comprises a received signal strength threshold.

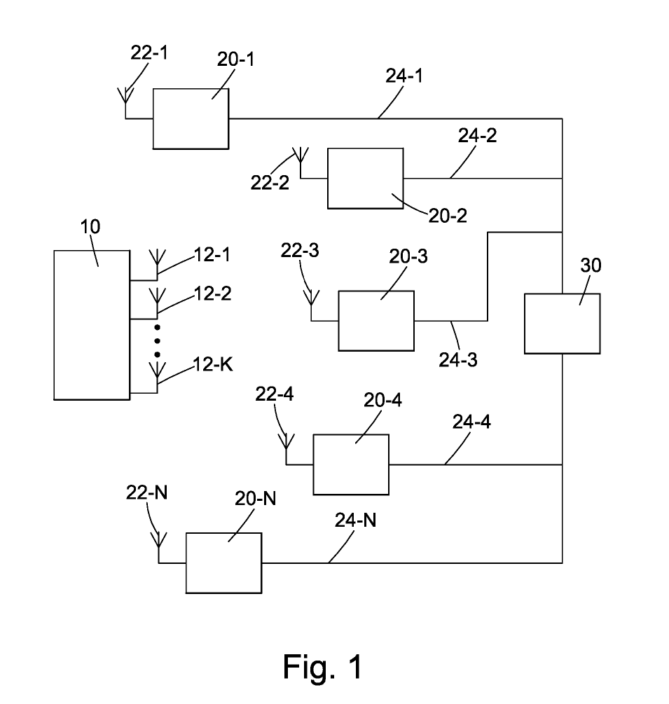

FIG. 1 shows a distributed antenna system (DAS) according to an embodiment. The DAS comprises N distributed remote radio heads (RRHs) 20-1, 20-2, 20-3, 20-4 . . . 20-N. Each of the RRHs 20-1, 20-2, 20-3, 20-4 . . . 20-N comprises an antenna 22-1, 22-2, 22-3, 22-4 . . . 22-N. The RRHs 20-1, 20-2, 20-3, 20-4 . . . 20-N are connected to a central unit (CU) 30 by backhaul connections 24-1, 24-2, 24-3, 24-4, 24-N.

A transmitting device 10 comprises K antennas 12-1, 12-2 . . . 12-K. The transmitting device 10 transmit signals to the N RRHs 20-1, 20-2, 20-3, 20-4 . . . 20-N. The RRHs 20-1, 20-2, 20-3, 20-4 . . . 20-N forward the received signals to the CU 30 via the backhaul connections 24-1, 24-2, 24-3, 24-4, 24-N. The CU 30 decodes the combined signal received from the N RRHs. In this embodiment, it is assumed that the transmitting device 10 sends K independent streams using spatial multiplexing and that each of the RRHs has a single antenna. The CU 30 uses a decoding technique such as minimum mean square error (MMSE), zero forcing (ZF) or maximum likelihood (ML) to recover the signals transmitted by the transmitting device 10 from the signals received from the RRHs 20-1, 20-2, 20-3, 20-4 . . . 20-N.

If the transmitted signal is x=[x₁, x₂, . . . , x_{K}]^{T}, where xⱼ is the signal stream transmitted from the j^{th} antenna of the transmitting device 10, the signal received at the ith RRH can be expressed as

rᵢ=\tilde{h}ᵢx+nᵢ

Where \tilde{h}ᵢ=[h_{i,1}, . . . , h_{i,K}], h_{i,j} is the channel between the ith receive and jth transmit antenna and nᵢ is the additive Gaussian noise term with variance σₙ².

If the signals from all RHHs are sent to the CU 30 for decoding, the combined received signals can be formulated as

r=Hx+n

where H=[\tilde{h}₁, \tilde{h}₂, . . . , \tilde{h}_{N}]^{T} is the tall channel matrix and n=[n₁, . . . , n_{N}]^{T} is the vector of noise terms. \tilde{h}ᵢ represents the ith row of the channel matrix H.

If MMSE processing is performed for instance, the recovered signal is given by

\hat{x}=Fₘₘₛₑr

with Fₘₘₛₑ=H^{†}(HH^{†}+σₙ²I)⁻¹. The superscript † in the expression refers to the Hermitian transpose of the matrix.

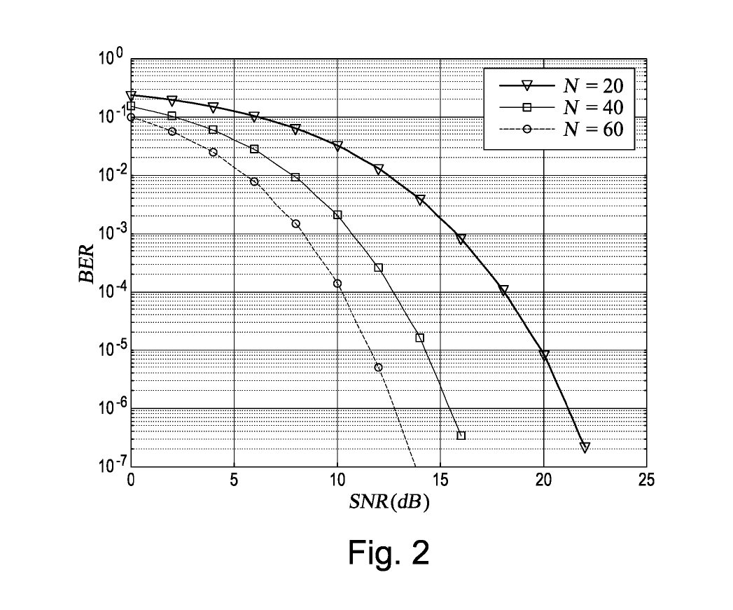

The bit error rate (BER) performance of an uplink DAS system such as that shown in FIG. 1 depends on the number of RRHs. An example of this dependence is shown in FIG. 2.

FIG. 2 shows a bit error rate (BER) comparison of an uplink DAS system with different numbers of RRHs. The plot shows BER against signal to noise ratio (SNR) for number of transmit antennas, N=20, 40 & 60. In this plot, it is assumed that the RRHs are positioned randomly between 1 and 3 m from the transmitting device and the number of antennas on the transmitting device, K=4.

As can be seen from FIG. 2, having more active RRHs participate in the signal recovery results in a reduction in SNR. However, the decrease in SNR when the number of active RRHs increases from N=20 to N=40 is considerably larger than the decrease in SNR when the number of active RRHs increases from N=40 to N=60. Using signals from more RRHs at the CU to leads to higher backhaul traffic and potentially delays in the processing/decoding at the CU. To address this issue, in embodiments, the CU may impose constraints on the average number of active backhaul links for every transmission instance. In other words, only a subset of the available RRHs will forward the signals they receive to the CU for decoding. In the following description, the number of active backhaul links on average is indicated by N′.

It is noted that the transmitting device 10 can be a mobile device and its movement changes its relative distance to the RRHs and thus the received signal power.

In embodiments, the decision to forward the received signals to the central unit is done locally at each RRH device. The RRH devices each compare a received signal strength indication with a threshold and if the received signal strength indication is above that threshold, the RRH forwards the signal to the CU. If the received signal strength indication is below the threshold, the RRH does not forward the signal to the CU. In one embodiment, the CU calculates the thresholds and transmits the thresholds to the RRH devices. In another embodiment, the threshold values are computed locally at the RRHs. The thresholds may be calculated based on control information sent by the CU to the RRHs. This control information may not be required again when the transmitter moves.

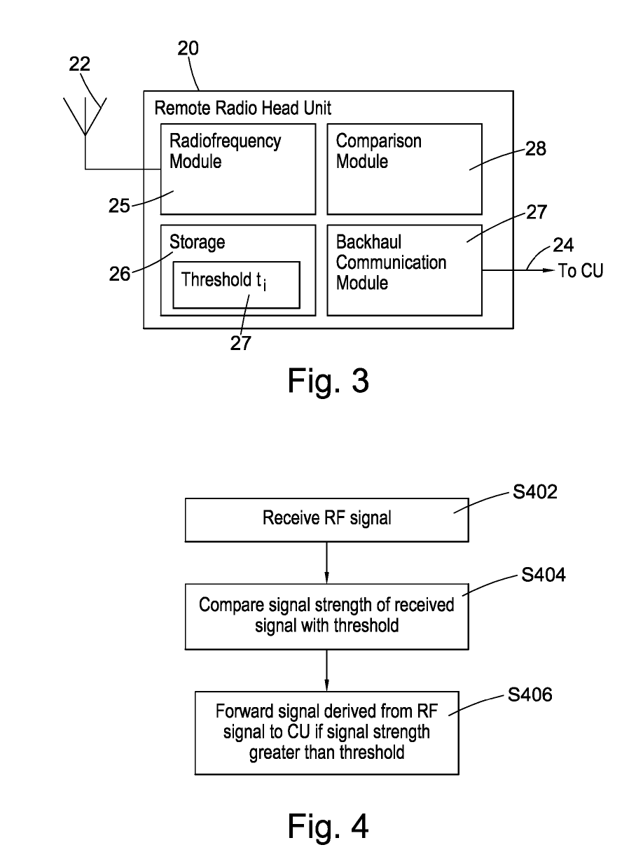

FIG. 3 shows a remote radio head unit according to an embodiment. The remote ratio head (RRH) unit 20 comprises an antenna 22, a radiofrequency module 25, storage 26, a comparison module 28 and a backhaul communication module 29. The storage stores a threshold tᵢ 27. The backhaul communication module is coupled to a backhaul connection 24 which connects the RRH unit 20 to a central unit (CU). The antenna 22 is configured to receive radiofrequency (RF) signals transmitted on a RF channel. The radiofrequency (RF) module 25 is configured to convert the received RF signals into baseband signals in the digital domain.

FIG. 4 shows a method of forwarding a received signal from a RRH to a CU according to an embodiment. The method shown in FIG. 4 is carried out by a RRH 20 as shown in FIG. 3. In step S402, the antenna 22 receives a RF signal transmitted by a transmitting device. The RF module 25 converts the received RF signal into a baseband signal. In step S404, the comparison module 28 compares the signal strength of the received signal in the baseband with the threshold tᵢ 27 stored in the storage 26. If the signal strength of the received RF signal is greater than the threshold ti, then in step S406, the backhaul communication module 29 forwards the baseband signal derived from the RF signal received by the antenna 22 to the CU via the backhaul connection 24.

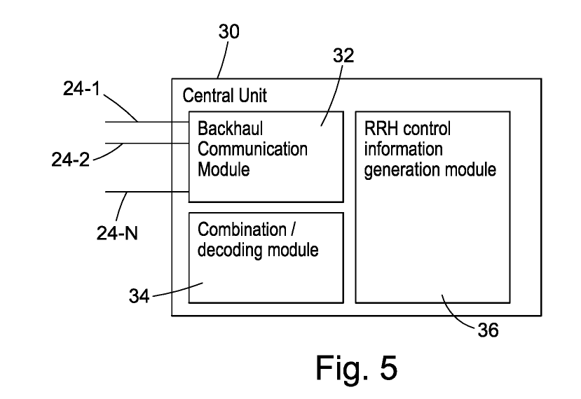

FIG. 5 shows a central unit (CU) according to an embodiment. The central unit 30 comprises a backhaul communication module 32 which is coupled to the backhaul connections 24-1, 24-2, . . . 24-N to the RRHs; a combination/decoding module 34 and a RRH control information generation module 36. The combination/decoding module 34 combines the signals received from each of the active RRHs and uses these signals to decode the information transmitted by the transmitter 10. The RRH control information generation module 36 generates control information for the RRHs. In one embodiment, this control information is a probability for each RRH that it will send a signal derived from the radiofrequency signal received on that RRH to the CU 30. In this embodiment, the RRHs use the control information to calculate the signal strength thresholds. In an embodiment, the control information sent by the CU 30 to the RRHs is a signal strength threshold for each of the RRHs.

Methods of setting the threshold will now be described. In one embodiment, the threshold is calculated for each RRH by the CU. In an embodiment the CU sends control data which specifies for example the transmit probability for every RRH and the threshold values are computed locally at the RRHs. In both cases, there is a single instance wherein the CU sends control information to the RRHs. This control information may not be required again when the transmitter moves.

In the following, details of embodiments are described. For illustration purposes, it is assumed that the channel fading distribution is Rayleigh and the RRHs are uniformly distributed within the a specified environment, with a density of ρ. It should be noted that in the large-scale setting with a large number of RRHs, the Rayleigh fading assumption is valid.

Since the RRHs are distributed in a random fashion around the transmitter, each row of H has a different variance due to different path losses. To take large scale fading into account in the analysis and design, the jth column of H is written as

hⱼ=Dⱼĥⱼ, j=1, . . . ,K

Where the entries of ĥⱼ are independent and identically distributed (iid) zero mean, unit variance, complex Gaussian random variables and

$${D}_{j} = diag ( \frac{1}{\sqrt{{d}_{i , {j}^{′}}^{η}}} , … , \frac{1}{\sqrt{{d}_{N , {j}^{′}}^{η}}} ) ,$$

d_{i,j} being the distance between the jth transmit and ith receive antenna and η is the path loss exponent. Since the transmit antennas are located on the same device in this illustration, we can assume without loss of generality that Dⱼ=D, ∀j. Let zᵢ=\tilde{h}ᵢ\tilde{h}ᵢ^{†} as a measure of the received signal strength indication at the ith RRH. As previously stated, \tilde{h}ᵢ is a length K row vector. If the ith RRH is at a distance rᵢ from the the transmitter, zᵢ is a Chi-squared random variable with 2K degrees of freedom and probability density function (pdf)

$${f}_{{Z}_{i}} ( z ) = \frac{1}{{σ}_{{h}_{i}}^{2 K} Γ ( K )} {z}^{K - 1} exp ( - \frac{z}{{σ}_{{h}_{i}}^{2}} )$$

where σₕ_{ᵢ}² is the variance of zᵢ given by σₕ_{ᵢ}²=rᵢ^{-η} and is related to the distance of the ith RRH from the transmitter, rᵢ. The cumulative density function is then given by

$${F}_{{Z}_{i}} ( a ) = \frac{1}{Γ ( K )} γ ( K , \frac{a}{{σ}_{{h}_{i}}^{2}} )$$

where γ(•,•) is the lower incomplete gamma function. In the described embodiments, given a received signal at a particular RRH, the decision on whether to forward the received signal to the central unit is performed locally by comparing the received signal strength to a given threshold, tᵢ. Under the above mentioned conditions, this probability that a RRH at a distance r forwards its received signal to the central unit can be expressed as

$$p ( r ) = P ( {z}_{i} \geq {t}_{i} ) = 1 - \frac{1}{Γ ( K )} γ ( K , \frac{{t}_{i}}{{σ}_{{h}_{i}}^{2}} )$$

In one embodiment, the central unit specifies the probability at which every RRH will forward its received signal to the CU for processing.

Let the probability of the ith RRH forwarding its received signal to the CU be pᵢ. This value of pᵢ is communicated from the CU to the ith RRH, ∀i.

At the ith RRH, the value of pᵢ can be used to derive the desired threshold tᵢ. In particular, if

$$1 - \frac{1}{Γ ( K )} γ ( K , \frac{{t}_{i}}{{σ}_{{h}_{i}}^{2}} ) = {p}_{i} ,$$

the remote head can compute the inverse of the gamma function to find tᵢ. Such computations can be achieved by using numerical methods such as the Newton's method, or by using approximations or bounds of the incomplete gamma function.

It is noted that there is a one-to-one mapping between a given value of pᵢ and tᵢ when K and σₕ_{ᵢ}² are fixed. It is assumed that every RRH is aware of its distance to the transmitter and the path loss exponent and can therefore compute σₕ_{ᵢ}².

In an embodiment, the central unit can specify that all RRHs would forward their signal with the same probability, i.e., pᵢ=p, ∀i. For a given average number of active backhaul links, N′,

$${p}_{i} = \frac{{N}^{′}}{N} .$$

In this example, the computation of the threshold values is performed at individual RRHs.

Alternately, pᵢ can be chosen based on optimization criteria, such as assigning a higher transmit probability to those RRHs that on average are closer to any transmitter than those further away. For instance, if a RRH is located in a place where it is more likely to have transmitters close by, the CU can assign a higher probability of transmission to that RRH when compared to others. In that case, the RRHs closer to the transmitter will forward the signal to the CU more often.

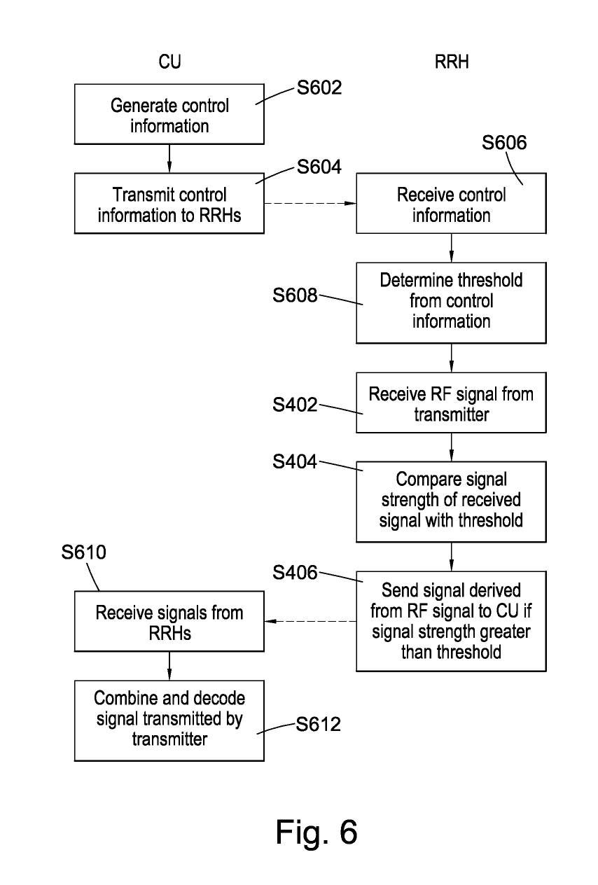

FIG. 6 shows a method in a DAS according to an embodiment. In the embodiment shown in FIG. 6, the CU sends control information to the RRHs such as a probability that each RRH will send signals derived from the RF signals that the RRH receives to the CU. The steps carried out by the CU are shown on the left hand side of FIG. 6 and the steps carried out by the RRHs are shown on the right hand side of FIG. 6.

In step S602, the CU generates control information for the RRHs to use to determine signal strength thresholds. The control information may as discussed above be the probability that each RRH will transmit a signal to the CU. In step S604, the CU transmits the control information to the RRHs. The CU uses the backhaul connections 24-1,24-2, . . . 24-N to transmit the control information to the RRHs.

In step S606, the RRHs receive the control information from the CU. In step S608, each RRH determines a signal strength threshold from the control information.

Steps S402, S404 and S406 are described above with reference to FIG. 4. In step S402, the RRH receives a RF signal from the transmitter. In step S404, the RRH compares the received signal strength with the threshold. In step S406, the RRH sends a signal derived from the RF signal to the CU if the received signal strength is greater than the threshold. It is noted that steps S402, S404 and S406 may be repeated using the same threshold. Additionally, as the threshold may depend on the location of the transmitter relative to the RRH and the channel conditions, if the transmitter moves relative to the RRH, step S608 may be repeated a number of times using the same control information.

In step S610, the CU receives signals from the active RRHs. As discussed above, on average N′ RRHs will be active and send signals to the CU. In step S612, the CU combines the signals received in step S610 and uses the combined information to decode the transmission from the transmitter.

In an embodiment, the central unit makes use of the knowledge of the density and distribution of the RRHs to calculate the threshold value of each RRH. The same threshold can be assigned to every RRH. In the large system setting, the N RRHs can be considered to be uniformly distributed around the transmitter. This argument is valid even if the user moves within the environment.

Let tᵢ=t, ∀i.

The average number of selected RRHs within a distance D from the transmitter can be computed using the following equation. Where D is related to the dimension over which the RRHs are spread and is known at the central unit.

ρ∫₀^{2π}∫₀^{D}rp(r)dr dθ=N′

p(r) in the above expression refers to the probability that a RRH at a distance r from the transmitter forwards the signal it receives to the central unit. The following double integral leads to the expression

$$Γ ( K ) ( {D}^{2} - \frac{{N}^{′}}{πρ} ) = {D}^{2} γ ( K , {tD}^{η} ) - \frac{1}{{t}^{\frac{2}{η}}} γ ( K + 2 , {tD}^{η} )$$

Using numerical methods such as Newton's method, the above expression, or its approximations, can be used to calculate the global threshold value of t for all RRHs. Observe that for a given tᵢ,

$$P ( {z}_{i} \geq {t}_{i} ) = 1 - \frac{1}{Γ ( K )} γ ( K , \frac{{t}_{i}}{{σ}_{{h}_{i}}^{2}} ) = 1 - \frac{1}{Γ ( K )} γ ( K , {t}_{i} {r}_{i}^{η} )$$

decreases monotonically with r.

Thus, RRHs further from the transmitter automatically have a lower probability of forwarding their signals. Note that this value of t needs to be computed centrally only once. The desired value of tᵢ can be obtained for example through a table lookup operation.

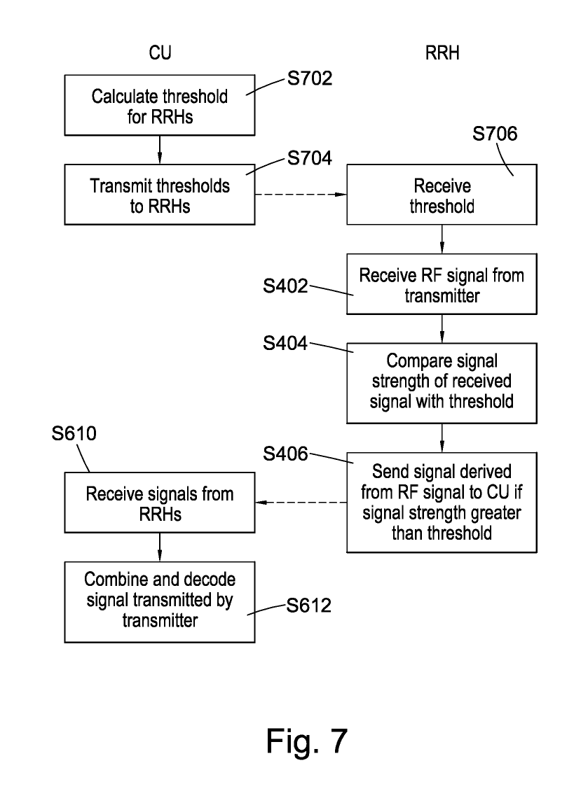

FIG. 7 shows a method in a DAS according to an embodiment. In the embodiment shown in FIG. 7, the CU determines thresholds for each of the RRHs and sends these thresholds or indications of the thresholds to the RRHs. The steps carried out by the CU are shown on the left hand side of FIG. 7 and the steps carried out by the RRHs are shown on the right hand side of FIG. 7.

In step S702, the CU calculates a signal strength threshold for each of the RRHs. The threshold may be the same for each RRH, or a different value may be calculated for each RRH. In step S704, the CU transmits the thresholds to the RRHs. In one embodiment, the RRHs and the CU may each store an indexed set of thresholds and the CU may transmit the index to each of the RRHs as an indication of the threshold for each RRH to use.

Steps S402, S404 and S406 are described above with reference to FIG. 4. In step S402, the RRH receives a RF signal from the transmitter. In step S404, the RRH compares the received signal strength with the threshold. In step S406, the RRH sends a signal derived from the RF signal to the CU if the received signal strength is greater than the threshold. It is noted that steps S402, S404 and S406 may be repeated using the same threshold.

In step S610, the CU receives signals from the active RRHs. As discussed above, on average N′ RRHs will be active and send signals to the CU. In step S612, the CU combines the signals received in step S610 and uses the combined information to decode the transmission from the transmitter.

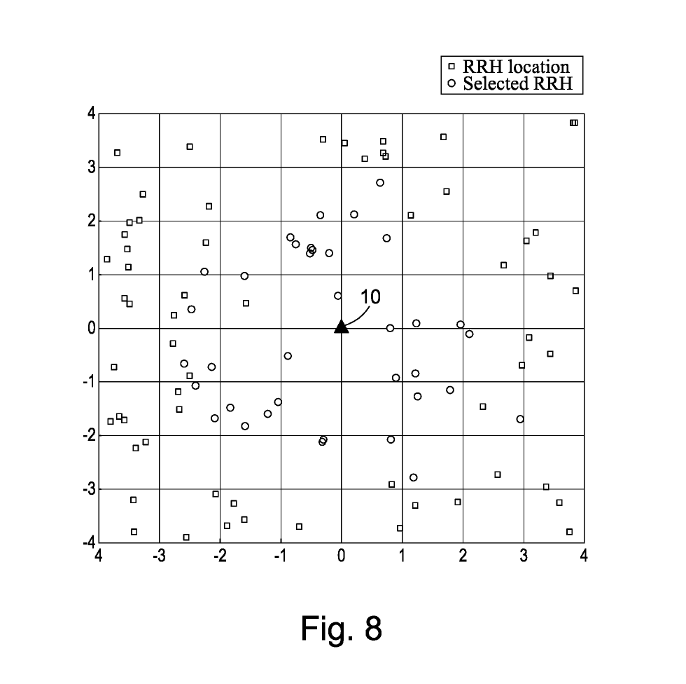

FIG. 8 shows an example of RRH selection in an embodiment. In FIG. 8, the transmitter 10 is located at the position (0,0) RRHs are represented by squares and the RRHs that send signals to the CU are represented by circles. In the example shown in FIG. 8, a constant threshold is set for all of the RRHs. As shown in FIG. 8, since the threshold is constant in this example, it is the RRHs that are closer to the transmitter that send signals to the CU as these RRHs receive signals from the transmitter having the highest strength.

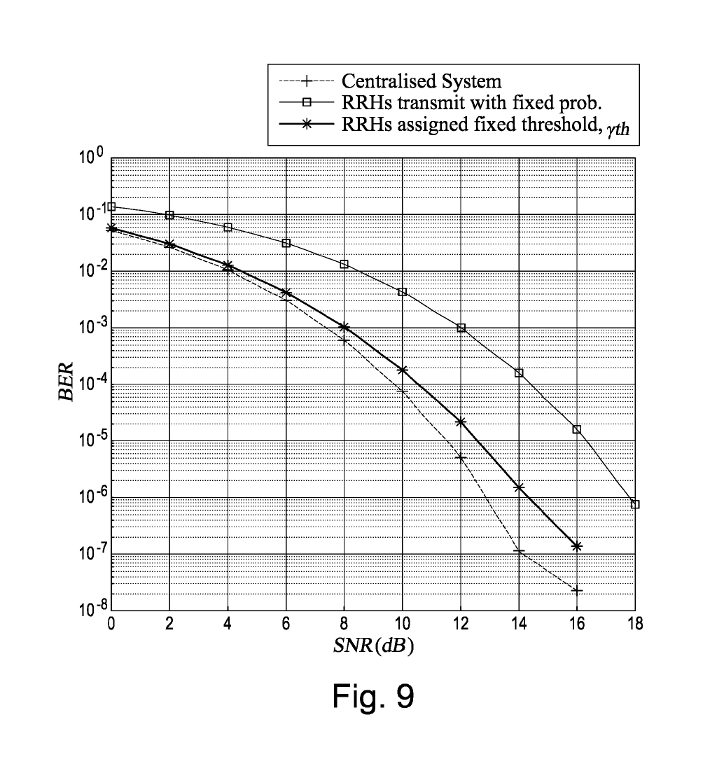

FIG. 9 shows a comparison of bit error rate (BER) against signal to noise ratio (SNR) for an embodiment where a fixed probability is sent to each of the RRHs and an embodiment in which each RRH is assigned a fixed threshold. FIG. 9 also shows the performance of a centralised system where the RRHs that send signals to the CU are selected by comparing all of the received signal strengths centrally at the CU.

As shown in FIG. 9 the embodiment in which fixed thresholds are sent to the RRHs has a better performance than the embodiment in which a probability is sent to the RRHs to use to calculate the thresholds. Further, the performance of the embodiment with fixed thresholds is close to that of the centralised system.

In embodiments the overhead on the backhaul involved in selecting the RRHs is fixed. Once the control information or thresholds have been sent to the RRHs, the RRHs determine in a distributed manner whether or not to send received signals to the CU.

The specific embodiments are presented schematically. The reader will appreciate that the detailed implementation of each embodiment can be achieved in a number of ways. For instance, a dedicated hardware implementation could be designed and built. On the other hand, a processor could be configured with a computer program, such as delivered either by way of a storage medium (e.g. a magnetic, optical or solid state memory based device) or by way of a computer receivable signal (e.g. a download of a full program or a “patch” update to an existing program) to implement the management unit described above in relation to the embodiments. Besides these two positions, a multi-function hardware device, such as a DSP, a FPGA or the like, could be configured by configuration instructions.

Whilst certain embodiments have been described, these embodiments have been presented by way of example only, and are not intended to limit the scope of the inventions. Indeed, the novel wireless stations, and methods described herein may be embodied in a variety of other forms; furthermore, various omissions, substitutions and changes in the form of the devices, methods and products described herein may be made without departing from the spirit of the inventions. The accompanying claims and their equivalents are intended to cover such forms or modifications as would fall within the scope and spirit of the inventions.

1. A remote radio head unit for a distributed antenna system, the remote radio head unit comprising:
an antenna configured to receive a radiofrequency signal;
a storage module for storing a signal strength threshold;
a comparison module configured to compare a signal strength of the radiofrequency signal with the signal strength threshold; and
a backhaul communication module configured to send a signal derived from the received signal to a central unit of the distributed antenna system if the signal strength of the radiofrequency signal is greater than the signal strength threshold.

2. A remote radio head unit according to claim 1, further comprising a threshold calculation module configured to calculate the signal strength threshold from control information received from the central unit of the distributed antenna system.

3. A remote radio head unit according to claim 2, wherein the control information received from the central unit of the distributed antenna system indicates a probability that the remote radio head unit will forward a signal to the central unit of the distributed antenna system.

4. A remote radio head unit according to claim 1, wherein the backhaul communication module is further configured to receive an indication of the signal strength threshold from the central unit of the distributed antenna system.

5. A remote radio head unit according to claim 1, further comprising a radiofrequency module configured to generate a baseband signal from the radiofrequency signal, wherein the signal derived from the radiofrequency signal is the baseband signal.

6. A signal processing method in a remote radio head unit of a distributed antenna system, the method comprising:
receiving a radiofrequency signal from a transmitter;
comparing a signal strength of the radiofrequency signal with the signal strength threshold;
sending a signal derived from the radiofrequency signal to a central unit of the distributed antenna system if the signal strength of the radiofrequency signal is greater than the signal strength threshold.

7. A signal processing method according to claim 6, further comprising
receiving control information from the central unit; and
calculating the signal strength threshold from the control information.

8. A signal processing method according to claim 6, further comprising
receiving an indication of the threshold from the central unit.

9. A signal processing method according to claim 6, further comprising determining a baseband signal from the radiofrequency signal and determining the signal strength of the radiofrequency signal from the baseband signal.

10. A signal processing method according to claim 9, wherein the signal derived from the radiofrequency signal is the baseband signal.

11. A central unit for a distributed antenna system, the distributed antenna system comprising a plurality of remote radio head units, the central unit comprising:
a control information generation module configured to generate control information for use by the remote radio head units to determine whether to transmit a signal derived from a received signal to the central unit; and
a communication module to send the control information to the remote radio head units.

12. A central unit according to claim 11, wherein the control information comprises a probability that a remote radio head will transmit a signal derived from a received signal to the control unit.

13. A central unit according to claim 11, wherein the control information comprises a received signal strength threshold.

14. A method in a central unit of a distributed antenna system, the distributed antenna system comprising a plurality of remote radio head units, the method comprising:
generating control information for use by the remote radio head units to determine whether to transmit a signal derived from a received signal to the central unit; and
sending the control information to the remote radio head units.

15. A method according to claim 14 wherein the control information comprises a probability that a remote radio head will transmit a signal derived from a received signal to the control unit.

16. A method according to claim 14 wherein the control information comprises a received signal strength threshold.

17. A non-transitory computer readable carrier medium carrying processor executable instructions which when executed on a processor cause the processor to carry out a method according to claim 7.

18. A non-transitory computer readable carrier medium carrying processor executable instructions which when executed on a processor cause the processor to carry out a method according to claim 14.
